(19) United States
(12) Patent Application Publication
(10) Pub. No.: US 2017/0331328 A1
(43) Pub. Date: Nov. 16, 2017

(54) MAGNETIC LEVITATION DEVICE WITH WIRELESS POWER TRANSMISSION

(71) Applicant: Beast Kingdom Co., Ltd., New Taipei City (TW)

(72) Inventor: Yung-Liang Yang, New Taipei City (TW)

(73) Assignee: Beast Kingdom, Co. Ltd

(21) Appl. No.: 15/202,483

(22) Filed: Jul. 5, 2016

(30) Foreign Application Priority Data
May 13, 2016 (TW) 105206993

(51) Int. Cl. H02J 50/10; H02J 7/02

(52) U.S. Cl. CPC H02J 50/10; H02J 7/025

(57) ABSTRACT

The present invention provides a magnetic levitation device comprising a base and a corresponding levitated object. The invention is characterized in that the base integrates a wireless power transmitting module and the levitated object integrates a wireless power receiving module. Given this arrangement, the base can transmit power wirelessly to further activate or control electronic components in the levitated object.

### BACKGROUND OF THE INVENTION

### Field of the Invention

The present invention relates to a magnetic levitation device, and more particularly, to a magnetic levitation device incorporating wireless power transmission technology.

### Description of the Prior Art

Magnetic levitation (or “maglev”) technology can be used to solve certain mechanical problems, such as reducing friction at linking points of mechanical components in order to improve output results or enhance mechanical performance. For example, maglev trains apply magnetic levitation technology to reduce friction between trains and tracks, and therefore trains can travel at very high speeds. Magnetic levitation technology has also been used for product display purposes. For example, a displayed object incorporating a magnetic element can be levitated above a base by using electromagnetic levitation techniques. To elevate the display effect of products, various display methods may be additionally employed to deliver a better visual effect for products. For example, light emitting components such as LED components may be used on a displayed product. However, LED components need to be activated with an additional power supply. If a power supply, such as a battery with a considerable size, is arranged on a displayed product employing magnetic levitation techniques, the additional weight of the power supply may affect the levitation result of the displayed product. And if the displayed product needs to use a cord to connect to the power supply, the visual effect of the display may be affected.

In view of the above, there is a need for a magnetic levitation device incorporating the wireless power transmission function.

### SUMMARY OF THE INVENTION

To address the needs as described above, the present invention provides a magnetic levitation device that integrates both electromagnetic levitation and wireless charging technologies in the same device. Electromagnetic levitation and wireless charging technologies are both related to electromagnetic induction, and the noise resulting from interference between magnetic fields is taken into consideration for the present invention. Accordingly, the magnetic levitation device of this invention reduces the impact of magnetic field noise to wireless charging and therefore allows wireless power transmission to operate more smoothly.

The present invention provides a magnetic levitation device, comprising: a first magnet set, arranged substantially along a first plane; a second magnet set, arranged substantially along a second plane and surrounding the first magnet set; and a transmitting coil, arranged substantially along a third plane and positioned between the first magnet set and the second magnet set. The transmitting coil electrically connects to a transmitting circuit such that the transmitting coil can be controlled to generate an induction signal.

The magnetic levitation device of the present invention further comprises a corresponding levitated object above said base. The levitated object comprises a magnetic element, and is levitated above the third plane by magnetic fields provided by the first magnet set and the second magnet set. The levitated object is characterized in comprising a receiving coil configured to receive the induction signal from the transmitting coil, whereas the induction signal is then converted to electrical energy and stored as power by a receiving circuit electrically connected to the receiving coil. The receiving coil defines a central axis, and the magnetic element of the levitated object is positioned substantially on the central axis of the receiving coil. The levitated object further comprises an electromagnetic wave absorbing element properly arranged to reduce noise that is to be received by the receiving coil.

These and other features, aspects and advantages of the present invention will become better understood with regard to the following description, appended claims and accompanying drawings that are provided only for further elaboration without limiting or restricting the present invention.

### BRIEF DESCRIPTION OF THE DRAWINGS

The present invention will become better understood with the following descriptions and accompanying drawings.

FIG. 1 is a top view schematically illustrating the arrangement of elements in a base of a magnetic levitation device according to an embodiment of the present invention.

FIG. 2 is a cross-sectional view of the base shown in FIG. 1, schematically showing the arrangement of the elements in the base.

FIG. 3 is a schematic view of a magnetic levitation device according to an embodiment of the present invention, showing the base in FIG. 2 and a corresponding levitated object above said base.

### DETAILED DESCRIPTION OF THE PREFERRED EMBODIMENTS

The present invention provides a magnetic levitation device which comprises not only an electromagnetic levitation (EML) device, but also a wireless power transmission device. An EML device applied for product display purpose generally comprises a base and a levitated object. The base typically comprises a power supply unit, a control unit (control circuit), a set of magnets arranged in a specific manner, and one or more coil combinations. The set of magnets are arranged to generate a particular magnetic field distribution around the base. The coils are arranged to electrically connect to the control unit, so that dynamic electromagnetic fields can be created. The levitated object has a magnetic element that repels the magnetic field distribution described above, and thus, the levitated object can be levitated above the base.

The wireless power transmission device mainly comprises a transmitter and a receiver. The transmitter comprises a transmitting circuit and a transmitting coil; the receiver comprises a receiving coil, which corresponds to the transmitting coil, and a power storage unit. The transmitting circuit can be independent of the control circuit described above. In an embodiment of the present invention, the transmitting circuit can also be integrated into the control circuit at a proper position. The transmitting circuit electrically connects to the control circuit and is driven to generate an induction signal. The receiving coil receives the induction signal, which is then converted to power and stored.

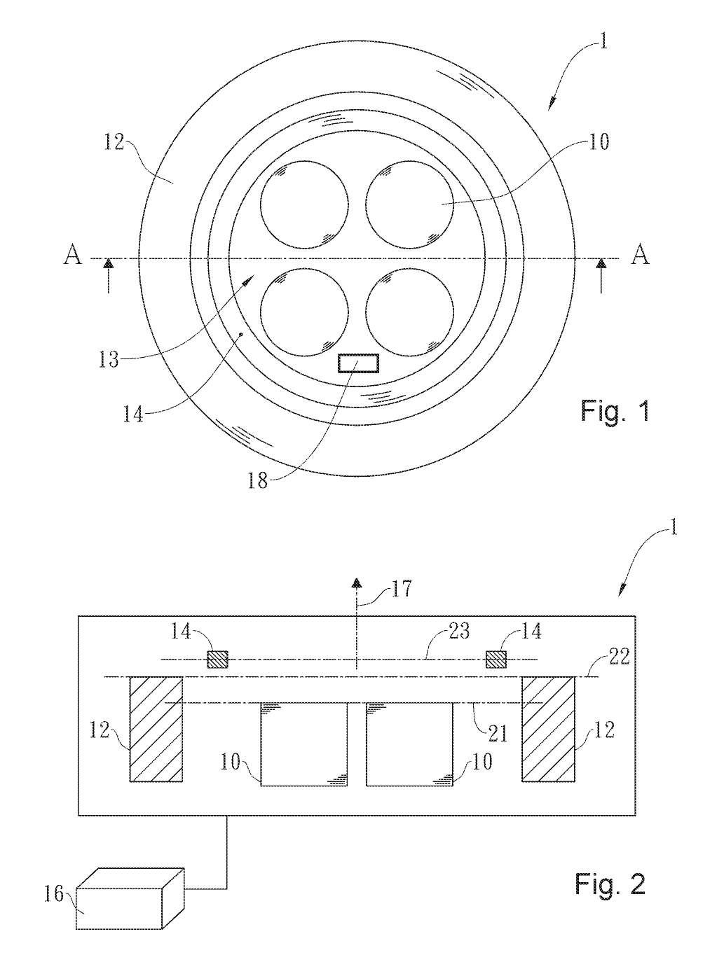

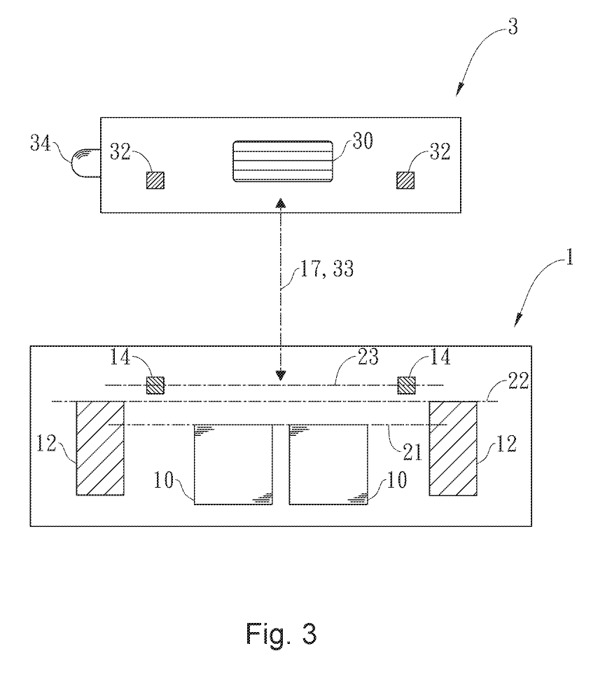

FIG. 1 illustrates an embodiment of the present invention, showing the arrangement of the elements contained in a base 1 of a magnetic levitation device. FIG. 1 shows a planar layout of the base, which faces a levitated object (as shown in FIG. 3). FIG. 2 is a cross-sectional view of the base of FIG. 1, showing vertical and horizontal relationships between the elements contained in the base.

The base 1 comprises a first magnet set 10, a second magnet set 12 and a transmitting coil 14. The first magnet set 10 includes a plurality of magnets having basically the same shape. Specifically, the first magnet set 10 is a set of electromagnets. In another embodiment of the invention, the first magnet set 10 may include magnets having two or more shapes. As FIG. 1 shows, the first magnet set 10 includes four rod magnets that are arranged symmetrically in a 2-by-2 form. The first magnet set 10 further includes a plurality of wire coils (not shown) to form an electromagnet set. Each wire coil is wound around each magnet of the first magnet set 10. The wire coils electrically connect to a control circuit (such as element 16 in FIG. 2), so that a control signal from the control circuit can be received to further generate a magnetic control field. Therefore, the electromagnet set having the first magnet set 10 can be controlled to provide particular magnetic field distributions selectively. Relevant details regarding arrangements of the electromagnets can be found in the Detailed Description of the Preferred Embodiments contained in Chinese Patent Publication No. CN1819436A.

The second magnet set 12 is arranged properly to surround the first magnet set 10. By properly arranging the first magnet set 10 and the second magnet set 12, the base can provide a proper magnetic field to support the levitated object. The second magnet set 12 shown in FIG. 1 is a ring magnet. In another embodiment of the invention, the second magnet set 12 may consist of a plurality of magnets spaced apart from one another. The second magnet set 12, such as a ring magnet, defines an accommodating space 13, and the first magnet set 10 is arranged within the accommodating space 13 defined by the second magnet set 12.

The transmitting coil 14 according to the present invention is arranged between the first magnet set 10 and the second magnet set 12. As shown in FIG. 1, the transmitting coil 14 is positioned substantially between the first magnet set 10 and the second magnet set 12, and is also positioned above these two elements. The transmitting coil 14 electrically connects to a transmitting circuit 18, which comprises an inductor unit that provides an inductance value suitable for the magnetic levitation device. The selection of a proper inductor value is associated with the first magnet set 10 and/or the second magnet set 12. The transmitting coil 14 and the transmitting circuit 18 form a transmitter, which generates an induction signal by the transmitting coil 14. Selecting a proper inductor value can improve the induction signal's transmission performance in the magnetic levitation device of this invention.

The control circuit 16 is configured to control the coils electrically connected to it, including the wire coils added to the first magnet set 10 and the transmitting coil 14. The control circuit 16 and the transmitting circuit 18 are electrically connected. In another embodiment of the invention, the transmitting circuit 18 has a dedicated control circuit within it, instead of an independent control circuit as described above. The control circuit 16 is formed by several electronic components arranged on a printed circuit board. This printed circuit board (not shown) can be used as a substrate carrying the first magnet set 10 and the second magnet set 12, and is accommodated within the base.

In an embodiment of the invention, the transmitting circuit 18 and the control circuit 16 are arranged on different printed circuit boards. As shown in FIG. 1, the transmitting circuit 18 is positioned within the accommodating space 13 defined by the second magnet set 12. The printed circuit board carrying the transmitting circuit 18 and the printed circuit board carrying the control circuit 16 are arranged to be substantially perpendicular to each other, whereas the printed circuit board carrying the control circuit 16 extends along a horizontal direction. In another embodiment of the invention, the transmitting circuit 18 is integrated into the control circuit 16. The control circuit 16 and the transmitting circuit 18 can be electrically connected, but operate individually.

In the magnetic levitation device of the present invention, the relative positions of the magnet sets and the transmitting coil are properly arranged to improve transmission performance of the induction signals. FIG. 2, a cross-sectional view in accordance with FIG. 1, shows that the first magnet set 10 is arranged substantially along a first plane 21; the second magnet set 12 is arranged substantially along a second plane 22; and the transmitting coil 14 is arranged substantially along a third plane 23. The first plane 21 is positioned lower than the second plane 22 so that the upper surfaces of the magnets in the first magnet set 10 are lower than the upper surface of the second magnet set 12. In another embodiment of the invention, the first plane 21 overlaps the second plane 22, so that the upper surfaces of the magnets in the first magnet set 10 substantially align with the upper surface of the second magnet set 12. Moreover, as shown in the illustrated embodiment, the third plane 23 is positioned higher than the first plane 21 and the second plane 22, so that the transmitting coil 14 is positioned relatively higher than the first magnet set 10 and the second magnet set 12. In another embodiment of the invention, the third plane 23 overlaps the second plane 22; for example, the transmitting coil 14 is arranged on the upper surface of the second magnet set 12.

The transmitting coil 14 defines a central axis 17. The first magnet set 10 and the second magnet set 12 are arranged symmetrically, substantially centering on the central axis 17. The central axis 17 is substantially perpendicular to the first plane 21, the second plane 22, and the third plane 23.

FIG. 3 shows the base 1 and a levitated object 3 of the magnetic levitation device according to the present invention. The levitated object 3 comprises a magnetic element 30. The magnetic element 30 interacts with the magnetic fields provided by the first and second magnet sets 10 and 12, thereby allowing the levitated object 3 to be levitated above the base 1 (or above the third plane 23). The magnetic element 30 is a magnet; in an embodiment of the invention, the magnetic element 30 has greater magnetic field strength than the first and second magnet sets 10 and 12. The levitated object 3 according to the present invention is characterized in that it comprises a receiving coil 32 for receiving an induction signal sent from the transmitting coil 14. The induction signal is then converted to electrical energy and stored as power by a receiving circuit (not shown) electrically connected to the receiving coil 32. For example, the receiving circuit may comprise a control circuit and a power storage element (e.g. a capacitor) for processing and storing the power which has been received wirelessly. The receiving coil 32 defines another central axis 33, and the magnetic element 30 is positioned substantially on the central axis 33 of the receiving coil 32. The magnetic element 30 and the receiving coil 32 are in different planes, whereas the receiving coil 32 is closer to the transmitting coil 14 in the base 1. In another embodiment of the invention, the magnetic element 30 and the receiving coil 32 are positioned substantially in the same plane. The radial dimension of the receiving coil 32 is substantially the same as that of the transmitting coil 14. In another embodiment of the invention, one or more receiving coils may be included.

When the central axis 33 of the receiving coil 32 substantially coincides with the central axis 17 of the transmitting coil 14, the levitated object 3 is basically at an equilibrium position in a horizontal direction because of the support of the first and second magnet sets 10 and 12. Moreover, when the wireless transmission of induction signals is activated, the receiving coil 32, which is located on the transmission path, can start storing power through the receiving circuit.

The levitated object 3 may have a light emitting element 34, such as an LED unit, arranged to electrically connect to the power storage element of the receiving circuit. When the wireless transmission of induction signals is activated, the converted and stored power can be used to activate the light emitting element 34 to create a special visual effect. By integrating the receiving coil and the receiving circuit, the levitated object of the magnetic levitation device according to this invention can have an enhanced visual effect, and the use of a considerably bulky battery or a cord that may affect the visual effect is no longer needed.

The levitated object 3 may further comprise an electromagnetic wave absorbing element (not shown). The electromagnetic wave absorbing element can be properly arranged in the levitated object 3 to reduce noise that is to be received by the receiving coil. The noise comes from the magnetic field(s) of the first magnet set 10 and/or the second magnet set 12.

All the planes as described in the above embodiments are horizontal planes, and each of them is substantially parallel to one another. While this invention has been described by way of examples and in terms of preferred embodiments, it is to be understood that this invention is not limited hereto, and that various changes, substitutions, and alterations can be made herein without departing from the spirit and scope of this invention as defined by the appended claims.

What is claimed is:

1. A magnetic levitation device, comprising:
a first magnet set, arranged substantially along a first plane;
a second magnet set, arranged substantially along a second plane and surrounding the first magnet set; and
a transmitting coil, arranged substantially along a third plane and positioned between the first magnet set and the second magnet set, the transmitting coil electrically connecting to a transmitting circuit such that the transmitting coil can be controlled to generate an induction signal.

2. The magnetic levitation device of claim 1, further comprising:
a levitated object comprising a magnetic element, the levitated object being levitated above the third plane by magnetic fields provided by the first magnet set and the second magnet set;
the levitated object characterized in comprising a receiving coil configured to receive the induction signal from the transmitting coil, the induction signal then being converted to electrical energy and stored as power by a receiving circuit electrically connected to the receiving coil.

3. The magnetic levitation device of claim 2, wherein the receiving coil defines a central axis and the magnetic element of the levitated object is positioned substantially on the central axis of the receiving coil.

4. The magnetic levitation device of claim 2, wherein the levitated object further comprises an electromagnetic wave absorbing element adaptively arranged to reduce noise that is to be received by the receiving coil.

5. The magnetic levitation device of claim 1, wherein the first plane overlaps the second plane.

6. The magnetic levitation device of claim 1, wherein the third plane overlaps the second plane.

7. The magnetic levitation device of claim 1, wherein the second magnet set defines an accommodating space, and the first magnet set and the transmitting circuit are arranged within the accommodating space.

8. The magnetic levitation device of claim 1, wherein the transmitting circuit comprises an inductor unit providing an inductance value adapted for the magnetic levitation device.
